(19) United States
(12) Patent Application Publication
(10) Pub. No.: US 2010/0322439 A1
(43) Pub. Date: Dec. 23, 2010

(54) CAPACITOR MICROPHONE UNIT AND CAPACITOR MICROPHONE

(76) Inventor: Hiroshi Akino, Tokyo (JP)

Correspondence Address: WHITHAM, CURTIS, CHRISTOFFERSON & COOK, P.C., SUITE 340, 11491 SUNSET HILLS ROAD, RESTON, VA, 20190, US

(21) Appl. No.: 12/817,938

(22) Filed: Jun. 17, 2010

(30) Foreign Application Priority Data
Jun. 18, 2009 (JP) 2009-144961

(51) Int. Cl. H04R 3/00

(52) U.S. Cl. 381/111

(57) ABSTRACT

A diaphragm adhering to a diaphragm holder and vibrating upon receiving a sound wave; and a fixed pole facing the diaphragm with a space from the diaphragm to form a capacitor with the diaphragm are included. A surface of the diaphragm holder adhering to the diaphragm is flat polished. The fixed pole is made of a flexible material. A surface of the fixed pole facing the diaphragm holder is pressure welded along the flat polished surface of the diaphragm holder.

### BACKGROUND OF THE INVENTION

1. Field of the Invention

The present invention relates to a capacitor-microphone unit and a capacitor microphone, and more specifically to a capacitor microphone unit and a capacitor microphone in which a space between a diaphragm and a fixed pole can be more surely maintained for higher performance.

2. Description of the Related Art

As is widely known, a capacitor microphone unit mainly includes: a diaphragm held by a diaphragm holder; and a fixed pole facing the diaphragm. A spacer is provided between the diaphragm and the fixed pole and thus a space corresponding to the thickness of the spacer is provided therebetween. FIG. 5 exemplary illustrates a capacitor microphone unit. In FIG. 5, a diaphragm 13 held by a diaphragm holder 12, a spacer 15, and a fixed pole 14 are incorporated in a unit casing 11 in this order. The unit casing 11 further incorporates an appropriate acoustic resistor, insulation holder, and electrode member. Thus, the capacitor microphone is formed.

A capacity of a capacitor formed between the diaphragm 13 and the fixed pole 14 facing each other varies as the space between the diaphragm 13 and the fixed pole 14 varies with the vibration of the diaphragm 13 upon receiving a sound wave. This variation in capacity is output as a sound signal generated by voltage variation. The diaphragm 13 is incorporated in the unit casing 11 while being adhered to the diaphragm holder 12 with certain tensile force applied thereto. A variation of the tensile force applied to the diaphragm 13 leads to a variation of frequency response characteristic of a microphone unit. The main cause of the variation of the tensile force applied to the diaphragm 13 is mechanical stress applied on the diaphragm holder 12 in an assembled microphone unit. Therefore, the diaphragm holder 12 is required to be rigid, i.e., to have high mechanical strength so as not to deform by the stress applied thereto in the assembled microphone unit.

The fixed pole 19 is required to maintain stable capacitance with the space between the fixed pole 14 and the diaphragm 13 kept constant. The fixed pole 14 may be displaced by a sound wave from outside. If the fixed pole 14 has mechanical strength more than 30 times as high as that of the diaphragm 13, the displacement of the fixed pole 14 due to a sound wave can be ignored. Unfortunately, even with the fixed pole 14 having sufficient mechanical strength, if the diaphragm 13 is displaced at a portion held between the diaphragm holder 12 and the fixed pole 14, the frequency response characteristic of the microphone unit varies. Therefore, the surfaces of the diaphragm holder 12 and the fixed pole 14 facing the diaphragm 13 are flat polished to improve the adhesion of the diaphragm 13 to the diaphragm holder 12 and the fixed pole 14. Thus, the displacement of the diaphragm 13 at the portion held between the diaphragm holder 12 and the fixed pole 14 is prevented.

FIGS. 6A and 6B exemplary illustrate the diaphragm holder 12, the diaphragm 13, and the fixed pole 14 in the conventional capacitor microphone unit. As illustrated in FIGS. 6A and 6B, the outer peripheral portion of the diaphragm 13 is adhered to the outer peripheral portion of the diaphragm holder 12 by means of, for example, adhesion. A large portion of the diaphragm 13, that is, a portion of the diaphragm 13 not including the peripheral adhered portion can vibrate upon receiving the sound wave and thus actually serves as a diaphragm portion. On the outer periphery of the surface of the diaphragm 13 opposite to the surface at which the diaphragm holder 12 is adhered, a spacer 15 is adhered. The fixed pole 14 is adhered on the spacer 15. As described above, the surfaces of the diaphragm holder 12 and the fixed pole 14 facing each other and facing the diaphragm 13 are flat polished. Thus, adhesion of the diaphragm 13 to the diaphragm holder 12 and the fixed pole 14 is improved. The diaphragm 13 and the spacer 15 are provided between the diaphragm holder 12 and the fixed pole 14. Therefore actually, the diaphragm holder 12 and the fixed pole 14 are in close contact with each other at the surfaces adhering to the diaphragm 13 and the spacer 15, respectively. The surface of the diaphragm holder 12 that faces, i.e., in close contact with the fixed pole 14 is given the reference numeral 121 while the surface of the fixed pole 14 that faces, i.e., is in closed contact with the diaphragm holder 12 is given the reference numeral 141.

The fixed pole may be formed of a printed circuit board. A printed circuit board has higher degree of freedom in the wiring of the electrode and designing of the surface for forming an effective capacitance. A copper foil layer from which a printed circuit pattern is formed is provided on the surface of the fixed pole formed of a printed circuit board facing the diaphragm. Thus, the copper foil layer is flat polished to improve adhesiveness of the diaphragm to the diaphragm holder and the fixed pole. Generally, a printed circuit board has highly uneven surface and thus needs to be heavily polished to be flat. Generally, a copper foil layer is thin because a thick copper foil layer is difficult to be formed. Since polishing cannot be performed over the thickness of the copper foil layer, the fixed pole may not be finished to a desired flatness. The thickness of a copper foil is about 35 micrometers. A copper foil on a printed circuit board which has an unevenness exceeding that thickness is polished away. In this case, function as a fixed pole cannot be provided.

No patent document disclosing a technique directly associated with the present invention was found. Japanese Patent Application. Publication No. 2008-154098 discloses a technique related to a method for manufacturing a fixed pole including an electret layer. More specifically, an innovation of a manufacturing method is disclosed with which the surface of the fixed pole on which the electret layer is formed can have a required quality, i.e., high flatness even with a shear drop produced at the peripheral portion in the course of flat polishing.

Japanese Patent Application Publication No. 2006-203749 discloses an electrostatic electro-acoustic transducer in which a fixed pole of a capacitor microphone unit includes: a fixed pole plate; a fixed pole ring provided on the periphery of the fixed pole plate; and an insulating section provided between the fixed pole plate and the fixed pole ring to integrally connect the fixed pole plate and the fixed pole ring. An object of the invention disclosed in Japanese Patent Application Publication No. 2006-203749 is to provide an electrostatic electro-acoustic transducer, e.g., a capacitor microphone, with a lower non-effective capacitance and higher sensitivity.

As described above, in a conventional capacitor microphone unit and a capacitor microphone formed therewith, the surfaces of the diaphragm holder and the fixed pole facing each other are flat polished to improve the adhesiveness of the diaphragm to the diaphragm holder and the fixed pole. Naturally, if flat polishing needs not to be performed on both diaphragm holder and fixed pole, and instead, for example, needs to be performed only on the diaphragm holder, cost for processing parts can be reduced.

Further, in a capacitor microphone unit having a fixed pole formed of a printed circuit board, if no flat polishing is needed on the fixed pole side, a copper foil layer from which a printed wire pattern is formed needs not to be polished. Therefore, lack of polishing margin as seen in the conventional example never occurs.

### SUMMARY OF THE INVENTION

The present invention is made in view of the above described conventional technique. An object of the present invention is to provide a capacitor microphone unit and a capacitor microphone in which, only a diaphragm adhering surface of the diaphragm holder needs to be flat polished to improve the adhesiveness of the diaphragm to the diaphragm holder and the fixed pole so that parts processing cost is lower, and no problem arises even if a fixed pole formed of a flexible material such as a printed circuit board is used.

A capacitor microphone unit according to an aspect of the present invention includes: a diaphragm adhering to a diaphragm holder and vibrating upon receiving a sound wave; and a fixed pole facing the diaphragm with a space from the diaphragm to form a capacitor with the diaphragm. A surface of the diaphragm holder adhering to the diaphragm, is flat polished. The fixed pole is made of a flexible material. A surface of the fixed pole facing the diaphragm holder is pressure welded along the flat polished surface of the diaphragm holder.

A capacitor microphone according to an aspect of the present invention includes the capacitor microphone unit according to the present invention incorporated in a microphone casing.

As described above, the fixed pole is made of a flexible material and is provided along the flat polished diaphragm adhering surface of the diaphragm holder facing the fixed pole. Therefore, the adhesiveness of the diaphragm to, the diaphragm holder and the fixed pole can be improved only by accurately flat polishing the diaphragm adhering Surface of the diaphragm holder. Thus, acoustic characteristics of the capacitor microphone unit and the capacitor microphone can be prevented from degrading with no fluctuation of tensile force applied to the diaphragm.

### BRIEF DESCRIPTION OF THE DRAWINGS

FIG. 1A is a cross-sectional longitudinal view of a main portion of an embodiment of a capacitor microphone unit in an assembled state;

FIG. 1B is a cross-sectional longitudinal view of a main portion of the embodiment of the capacitor microphone unit in an unassembled state;

FIG. 2A is a front view of a diaphragm holder in the embodiment;

FIG. 2B is a longitudinal cross-sectional view of the diaphragm holder in the embodiment;

FIG. 2C is a rear view of the diaphragm holder in the embodiment;

FIG. 3 is a front view of a spacer in the embodiment;

FIG. 4 is a front view of a fixed pole in the embodiment;

FIG. 5 is a longitudinal cross-sectional view of a capacitor microphone unit;

FIG. 6A is a cross-sectional longitudinal view of a main portion of a conventional capacitor microphone unit in an assembled state; and

FIG. 6B is a cross-sectional longitudinal view of a main portion of the conventional capacitor microphone unit in an unassembled state.

### DETAILED DESCRIPTION OF THE PREFERRED EMBODIMENTS

An embodiment of a capacitor microphone unit and a capacitor microphone according to the present invention is described below with reference to some of the accompanying drawings.

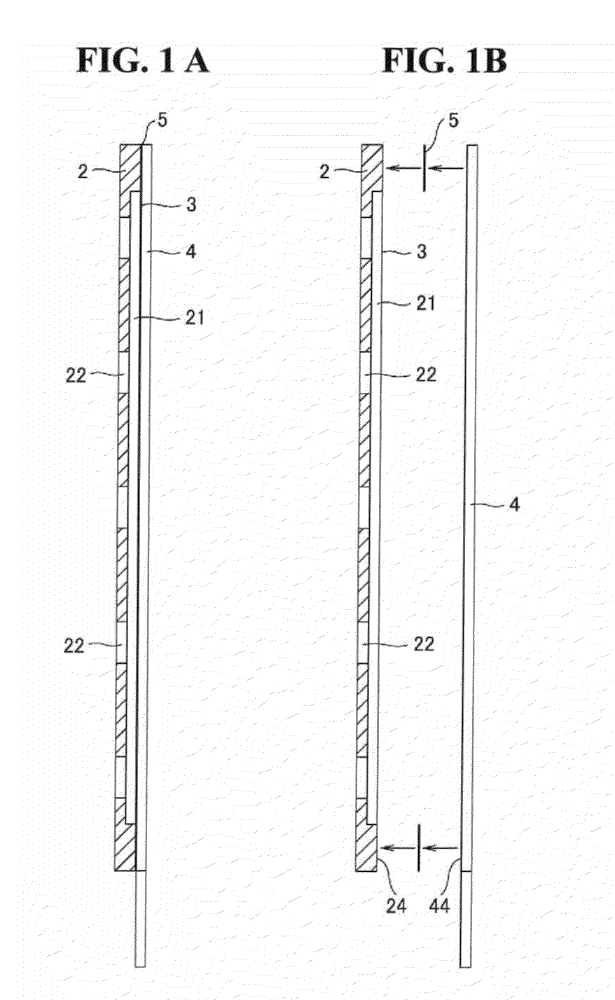

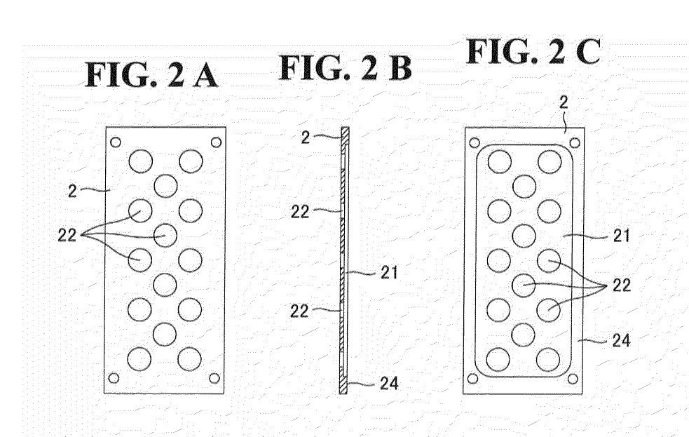

A diaphragm holder 2, a diaphragm 3, a fixed pole 4, and a spacer 5 are illustrated in FIGS. 1A and 1B. As illustrated in FIG. 2, the diaphragm holder 2 is formed of, for example, a rectangle plate-like metal material. An outer peripheral portion of one surface of the plate is formed into a protruding shape. It may also be regarded that the surface of the diaphragm holder 2 except the protruding portion is sinking towards the thickness direction in a certain depth to form a cavity 21. The protruding portion serves as a diaphragm adhering surface 24 on which the peripheral portion of the diaphragm 3 is adhered by means of, for example, adhesion. Window holes 22 penetrating the diaphragm holder 2 in the thickness direction through which a sound wave enters are formed on the diaphragm holder 2 as much as required.

Generally, a diaphragm holder in a capacitor microphone has a shape of a ring and relatively low mechanical strength or rigidity. The diaphragm holder 2 in the embodiment illustrated in the figure, on the other hand, is formed of a plate-like metal member, and thus has rigidity substantially higher than that of the fixed pole 4. Thus, as will be described later, adhesiveness of the diaphragm 3 on the diaphragm holder 2 and the fixed pole 4 can be improved just by accurately flat polishing the diaphragm adhering surface 24 of the diaphragm holder 2.

The diaphragm 3 is formed of, for example, a film-like member having a thickness of about 2 micrometers. The peripheral portion of the diaphragm 3 adheres to the diaphragm adhering surface 24 of the diaphragm holder 2 with an appropriate tensile force applied to the diaphragm 3. The diaphragm 3 has a rectangular shape to match the shape of the diaphragm holder 2.

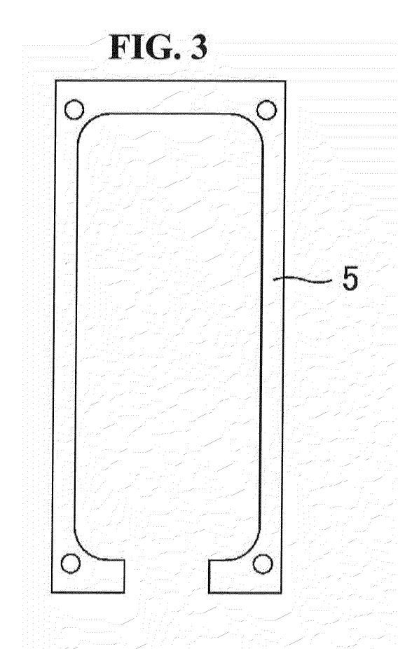

The spacer 5 is stacked on the diaphragm 3 adhered on the diaphragm adhering surface 24 to be integrally held by the diaphragm holder 2. The fixed pole 4 is stacked on the spacer 5. The spacer 5 is formed of, for example, a thin stainless plate having a shape of a rectangular frame to match the shape of the diaphragm adhering surface 24 of the diaphragm holder 2 as illustrated in FIG. 3. The diaphragm 3, the fixed pole 4, and the spacer 5 therebetween are bonded with pressure. Thus, a space corresponding to the thickness of the spacer 5 is provided between the diaphragm 3 and the fixed pole 4.

The diaphragm holder 2 has high mechanical strength and rigidity, while the fixed pole 4 has low mechanical strength and rigidity to be flexible. Thus, pressing of the fixed pole 4 towards the diaphragm adhering surface 24 of the diaphragm holder 2 results in the surface of the fixed pole 4 facing the diaphragm adhering, surface 24 being pressure welded along the diaphragm adhering Surface 24.

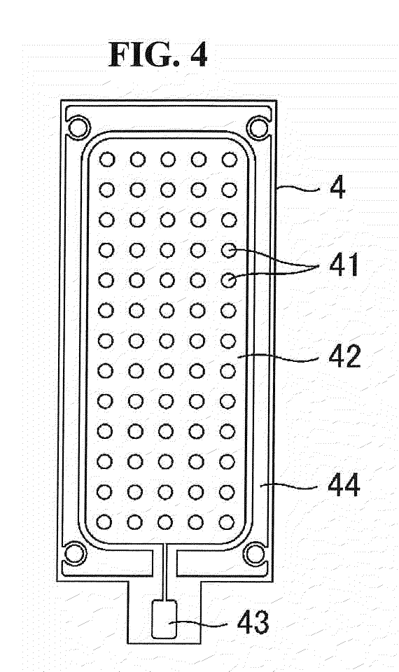

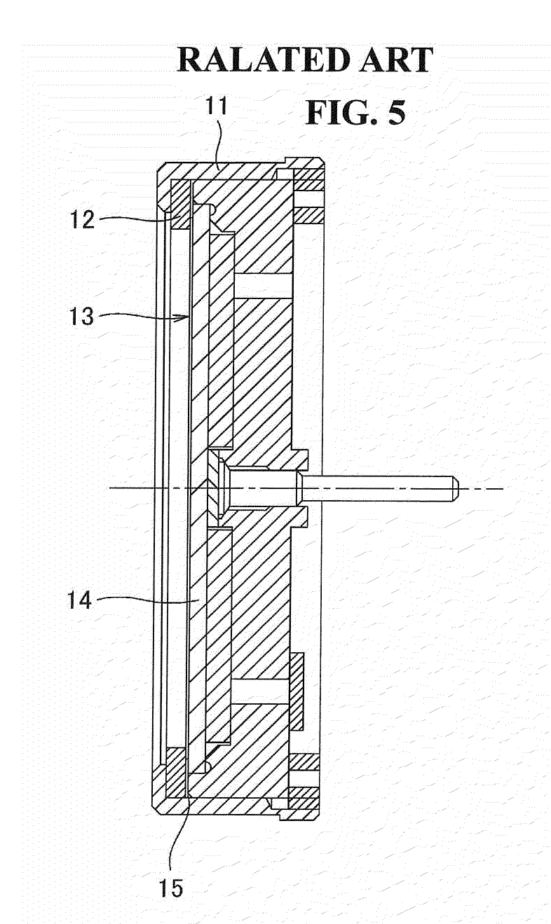

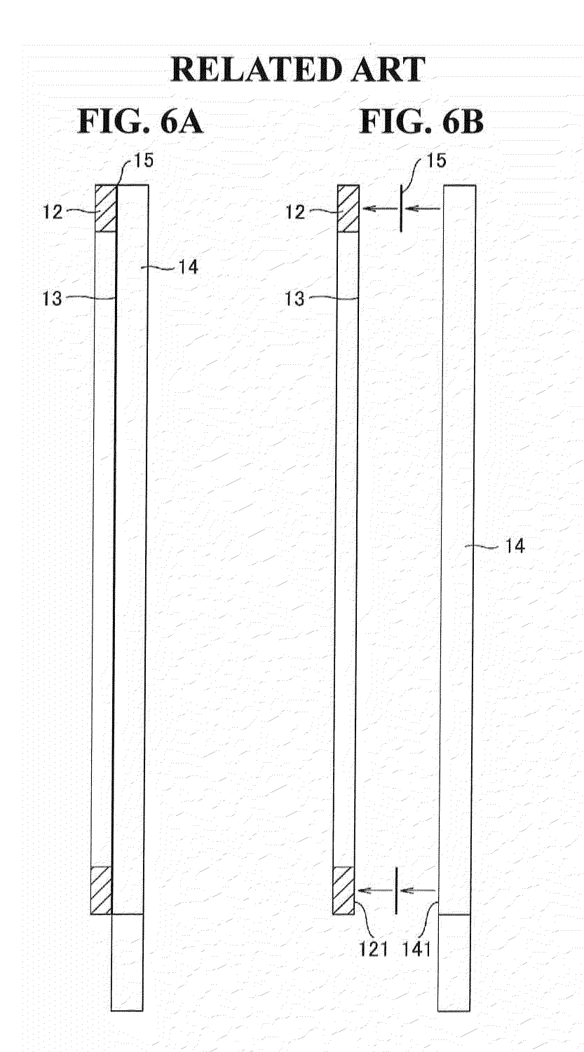

As shown in FIG. 4, the fixed pole 4 has a rectangular shape like the diaphragm holder 2, the diaphragm 3, and the spacer 5. As described above, the fixed pole 4 is formed of a flexible material. In this embodiment, the fixed pole 4 is a glass epoxy printed circuit board having a thickness of about 0.5 millimeter. Thus, the diaphragm holder 2 has more than 30 times as high mechanical strength or rigidity than the fixed pole 4. A plurality of circular holes 41 serving as rear acoustic terminals is formed on the fixed pole 4. With the printed pattern, an inner conducting section 42 and an outer conducting section 44 are formed on the front surface of the fixed pole 4, i.e., the surface of the fixed pole 4 facing the diaphragm 3. The inner conducting section 42 has a rectangular shape to match the area of the diaphragm 3 actually serving as a diaphragm. The outer conducting section 44 has a shape of a rectangular frame substantially same as that of the spacer 5 and surrounds the inner conducting section 42. Outer periphery of the fixed pole 4 partly projects outward and a terminal pattern 43 that is electrically connected to the inner conducting section 42 is provided at the projected portion. The inner conductive section 42 serves as one electrode of the capacitor formed with the fixed pole 4 and the diaphragm 3. The electrode of the capacitor can be connected to an external circuit through the terminal pattern 43.

The outer conductive section 44 of the fixed pole 4 is provided so that the fixed pole 4 has a flat surface facing the diaphragm 3. The fixed pole 4 can serve as a fixed pole if the inner conducting section 42 is formed on the surface thereof facing the diaphragm 3. However, if only the inner conducting section 42 is formed, there is a difference in the level between the surface of the inner conducting section 42 and the surface of the peripheral portion of the fixed pole 4. Therefore, the outer conducting section 44 is provided so that the inner conducting section 42 and the outer conducting section 44 form a flat surface. Thus, only by providing the spacer 5 between the diaphragm 3 held by the diaphragm holder 2 and the fixed pole 4, a space corresponding to the thickness of the spacer 5 can be formed therebetween.

A unit holder casing incorporates the diaphragm holder 2, the diaphragm 3, the spacer 5, and the fixed pole 4 in this order. The unit holder casing further incorporates an electrical circuit including an impedance converter such as a FET. Thus, a capacitor microphone unit is formed. Before assembling the capacitor microphone unit, the surface of the diaphragm adhering surface 24 of the diaphragm holder 2 (see, FIG. 1B, FIG. 2 B) is flat polished, to have accurate flatness. The diaphragm 3 is adhered on the flat polished surface. The flat polished surface and the outer conducting section 44 of the fixed pole 4 are pressed with the diaphragm 3 and the spacer 5 provided therebetweeen. Thus, the members are bonded with pressure.

In the above described embodiment, the diaphragm adhering surface 24 of the diaphragm holder 2 is flat polished. The fixed pole 4 made of a flexible material is pressed towards the diaphragm holder 2. Thus, the outer conducting section 44 facing the spacer 5 is pressure welded along the flat polished surface of the diaphragm holder 2. Thus, adhesiveness between: the diaphragm holder 2 and the diaphragm 3; the diaphragm 3 and the spacer 5; and the spacer 5 and the fixed pole 4 improves. Accordingly, degradation of acoustic property of the capacitor microphone unit can be prevented with less variation in tensile force applied to the diaphragm 3, and the space between the diaphragm 3 and the fixed pole 4 surely maintained. Further, only the diaphragm holder 2 needs to be flat polished and the fixed pole 4 pressure welded towards the diaphragm holder 2 needs not to be flat polished. Thus, the manufacturing process can be simplified.

An advantage of the embodiment illustrated in the figures is that the diaphragm 3 can have a large effectively vibrating area because the diaphragm holder 2, the diaphragm 3, the spacer 5, and the fixed pole 4 all have rectangular shape. It is to be noted that, in the present invention, the shape of the above elements is not limited to rectangle and can also be circular or other appropriate shapes.

Furthermore, in the embodiment illustrated in the figures, the inner conductive section 42 and the outer conductive section 44 are formed on the surface of the fixed pole 4 facing the diaphragm 3. Thus, a capacitor is formed only by the inner conductive section 42 and the diaphragm 3. Thus, stray capacitance can be minimized and an acoustic characteristic such as S/N ratio can be improved.

The fixed pole 4 of the illustrated embodiment is a printed circuit board and no flat polished is required on the copper foil layer thereof. Therefore, the fixed pole 4 never loses its function due to the copper foil being polished away.

A capacitor microphone unit can be formed by incorporating the above described capacitor microphone, a required circuit, a connector, and the like in a microphone casing.

The present invention is preferably applied to a capacitor microphone unit and a capacitor microphone that require high processing accuracy to have relatively high performance.

1. A capacitor microphone unit comprising:
a diaphragm adhering to a diaphragm holder and vibrating upon receiving a sound wave; and
a fixed pole facing the diaphragm with a space from the diaphragm to form a capacitor with the diaphragm, wherein
a surface of the diaphragm holder adhering to the diaphragm is flat polished,
the fixed pole is made of a flexible material, and
a surface of the fixed pole facing the diaphragm holder is pressure welded along the flat polished surface of the diaphragm holder.

2. The capacitor microphone unit according to claim 1, wherein a space is formed between the diaphragm and the fixed pole by providing a spacer between the diaphragm and the fixed pole.

3. The capacitor microphone unit according to claim 1, wherein the diaphragm holder is made of a material that is harder than a material of the fixed pole.

4. The capacitor microphone unit according to claim 1, wherein the fixed pole is formed of a printed circuit board.

5. The capacitor microphone unit according to claim 1, wherein the diaphragm holder is formed of a plate-like material in which a peripheral portion on one surface is formed into a protruding shape.

6. The capacitor microphone unit according to claim 5, wherein a window hole through which a sound wave passes is formed on the diaphragm holder formed of a plate-like material.

7. The capacitor microphone unit according to claim 2, wherein the diaphragm, the diaphragm holder, the fixed pole, and the spacer have a rectangular shape.

8. A capacitor microphone comprising:
a microphone casing; and
a capacitor microphone unit incorporated in the microphone casing, wherein the capacitor microphone unit comprises
a diaphragm adhering to a diaphragm holder and vibrating upon receiving a sound wave; and
a fixed pole facing the diaphragm with a space from the diaphragm to form a capacitor with the diaphragm, wherein
a surface of the diaphragm holder adhering to the diaphragm is flat polished,
the fixed pole is made of a flexible material, and
a surface of the fixed pole facing the diaphragm holder is pressure welded along the flat polished surface of the diaphragm holder.

9. A capacitor microphone as recited in claim 8, wherein in the capacitor microphone unit a space is formed between the diaphragm and the fixed pole by providing a spacer between the diaphragm and the fixed pole.

10. A capacitor microphone as recited in claim 8, wherein in the capacitor microphone unit the diaphragm holder is made of a material that is harder than a material of the fixed pole.

11. A capacitor microphone as recited in claim 8, wherein in the capacitor microphone unit the fixed pole is formed of a printed circuit board.

12. A capacitor microphone as recited in claim 8, wherein in the capacitor microphone unit the diaphragm holder is formed of a plate-like material in which a peripheral portion on one surface is formed into a protruding shape.

13. A capacitor microphone as recited in claim 12, wherein in the capacitor microphone unit a window hole through which a sound wave passes is formed on the diaphragm holder formed of a plate-like material.

14. A capacitor microphone as recited in claim 9, wherein in the capacitor microphone unit the diaphragm, the diaphragm holder, the fixed pole, and the spacer have a rectangular shape.
